(19) United States
(12) Patent Application Publication
(10) Pub. No.: US 2023/0121739 A1
(43) Pub. Date: Apr. 20, 2023

(54) REGISTER BOX ADAPTABLE TO DUCTWORK OF AN HVAC SYSTEM

(71) Applicant: STERLING CUSTOM SHEET METAL, INC., Magnolia, TX (US)

(72) Inventor: Sterling Kidd COMBS, Magnolia, TX (US)

(21) Appl. No.: 18/055,557

(22) Filed: Nov. 15, 2022

Related U.S. Application Data
(63) Continuation-in-part of application No. 17/196,678, filed on Mar. 9, 2021.
Application No. 17/196,678 is a continuation-in-part of application No. 17/175,956, filed on Feb. 15, 2021.
Application No. 17/175,956 is a continuation-in-part of application No. 17/175,922, filed on Feb. 15, 2021.
Application No. 17/175,922 is a continuation-in-part of application No. 17/171,638, filed on Feb. 9, 2021.
Application No. 17/171,638 is a continuation-in-part of application No. 16/036,059, filed on Jul. 16, 2018, now Pat. No. 11,060,756.
Application No. 16/036,059 is a continuation-in-part of application No. 15/864,612, filed on Jan. 8, 2018, now Pat. No. 10,995,969.
Application No. 15/864,612 is a division of application No. 14/668,079, filed on Mar. 25, 2015, now Pat. No. 9,951,969.
Application No. 16/036,059 is a continuation-in-part of application No. 16/005,235, filed on Jun. 11, 2018, now Pat. No. 11,402,121.
Application No. 16/005,235 is a continuation-in-part of application No. 15/703,436, filed on Sep. 13, 2017, now Pat. No. 10,648,695.
Application No. 15/703,436 is a continuation-in-part of application No. 15/439,454, filed on Feb. 22, 2017, now Pat. No. 10,309,682.
Application No. 15/439,454 is a continuation-in-part of application No. 14/668,079, filed on Mar. 25, 2015, now Pat. No. 9,951,969.

(51) Int. Cl. F24F 13/08; B29C 41/20; F24F 13/06; B29C 44/18

(52) U.S. Cl. CPC F24F 13/082; B29C 41/20; F24F 13/06; B29C 44/18; B29K 2075/00

(57) ABSTRACT

A register box for an HVAC installation has a body with a plurality of side panels arranged in a generally rectangular or square configuration and a wall extending in generally transverse relation to the plurality of side panels, and an expandable polymeric material affixed to an inner side of the side panels and across the wall. The wall has a plurality of concentric circular areas cut into the wall. Each of the concentric areas is formed of a first partial circle having ends in spaced relation to a second partial circle. The circular area can be removed from the wall so as to allow a user to cut through the polymeric material at the wall so as to form a hole opening to an interior of the register box. This hole can receive a collar therein. The collar can be connected to the HVAC system.

### CROSS-REFERENCE TO RELATED APPLICATIONS

The present application is a continuation-in-part of U.S. patent application Ser. No. 17/196,678, filed on Mar. 9, 2021, presently pending. U.S. patent application Ser. No. 17/196,678 is a continuation-in-part of U.S. patent application Ser. No. 17/175,956, filed on Feb. 15, 2021, presently pending. U.S. patent application Ser. No. 17/175,956, is a continuation-in-part of U.S. patent application Ser. No. 17/175,922, filed on Feb. 15, 2021, presently pending. U.S. patent application Ser. No. 17/175,922 is a continuation-in-part of U.S. patent application Ser. No. 17/171,638, filed on Feb. 9, 2021, presently pending. U.S. patent application Ser. No. 17/171,638 is a continuation-in-part of U.S. patent application Ser. No. 16/036,059, filed on Jul. 16, 2018, which issued as U.S. Pat. No. 11,060,756 on Jul. 13, 2021. U.S. patent application Ser. No. 16/036,059 is a continuation-in-part of U.S. patent application Ser. No. 15/864,612, filed on Jan. 8, 2018, which issued as U.S. Pat. No. 10,995,969 on May 4, 2021. U.S. patent application Ser. No. 15/864,612 is a divisional of U.S. patent application Ser. No. 14/668,079, filed Mar. 25, 2015, which issued as U.S. Pat. No. 9,951,969 on Apr. 24, 2018. U.S. patent application Ser. No. 16/036,059 was also a continuation-in-part of U.S. patent application Ser. No. 16/005,235, filed on Jun. 11, 2018, which issued as U.S. Pat. No. 11,402,121 on Aug. 2, 2022. U.S. patent application Ser. No. 16/005,235 is a continuation-in-part of U.S. patent application Ser. No. 15/703,436, filed on Sep. 13, 2017, which issued as U.S. Pat. No. 10,648,695 on May 12, 2020. U.S. patent application Ser. No. 15/703,436 is a continuation-in-part of U.S. patent application Ser. No. 15/439,454, filed Feb. 22, 2017, and which issued as U.S. Pat. No. 10,309,682 on Jun. 4, 2019. U.S. patent application Ser. No. 15/439,454 was a continuation-in-part of U.S. patent application Ser. No. 14/668,079, filed on Mar. 25, 2015, and which issued as U.S. Pat. No. 9,951,969 on Apr. 24, 2018.

### BACKGROUND OF THE INVENTION

### 1. Field of the Invention

The present invention relates to ductwork for heating, ventilation and air-conditioning (HVAC) systems. More particularly, the present invention relates to register boxes as used in such systems. More particularly, the present invention relates to register boxes that are adaptable to the various sizes of ductwork employed in the HVAC systems.

### 2. Description of Related Art Including Information Disclosed Under 37 CFR 1.97 and 37 CFR 1.98

To create the desired ambient conditions within a structure, a typical HVAC system is installed for circulating and/or conditioning air drawn from the interior of the structure and returned to the interior of the structure. A central unit or several units are located in or near the structure, each unit comprising a fan for air circulation and optionally comprising a heating, humidification, or cooling system for conditioning the air passing through the central unit.

To conduct air to and from each central unit, ducting is provided in the structure. The ducting includes supply-air ducts which provide conditioned air to the interior of the structure and are connected to the outlets of each central unit and return-air ducts which return air to each central unit and are connected to inlets of each central unit. Supply-air ducts typically terminate in supply-air register boxes mounted to the walls, the ceilings, or other surfaces within the interior, whereas return-air ducts typically begin at register boxes mounted to a surface within the interior, such as a wall, ceiling, or floor. There are usually many more register boxes for supplying air than for returning air, with those for returning air typically being substantially larger than those for supplying air.

To increase efficiency, building codes are being revised to require substantially airtight HVAC systems. In the past, a standard technique has been utilized for forming such sheet-metal register boxes. A form is cut from a rectangular, planar metal sheet. The form has cutouts for corners or other features to allow bending of the form into the desired shape. Cutouts define the height of the sides and an overlapping flap is formed by cutting a slot at each cut out. The sides are bent along bend lines to lie in intersecting planes so as to form an open-bottom, rectangular enclosure of a register box, with the vertical edges of the sides abutting the inside surfaces of the sides. The flap is folded around each corner that lies adjacent the outer surface of the side and then fastened to the side with rivets. In order to complete the register box, a circular duct connector or is connected to a circular cutout in the upper surface of the box. Prior art register boxes are also formed with abutting edges to form the enclosure. The abutting or overlapping edges may be fastened by adhering or by other fastening means, such as spot welding.

The method described above produces ducting enclosures that often leak conditioned air through the gaps between the edges at the corners, or, in the case of enclosures formed with multiple pieces, through the seams where the pieces are joined together. The prior-art method includes many labor-intensive steps to form the enclosures, including the cutting of the planar sheet and the fastening of the edges.

In order to achieve the requisite efficiency in compliance with building codes, insulation is used with such register boxes. The formation of the insulation of the register boxes has become somewhat of a problem. Since the boxes are conventionally made of sheet metal, such as galvanized steel or aluminum, the insulation must be applied to either or both the inside and outside of the register box either before or after it is installed. The cutting and fastening of the insulation to the box is tedious and time-consuming. As such, it is thereby rather expensive in terms of the cost of the insulation material and in terms of the amount of time required to properly insulate the register box.

The placement of insulation can be a time-consuming, hazardous, and tedious task. Typically, a large section of fibrous material requires a cutting into various shapes that fit within the interior of the register box. This fibrous material is then affixed to the walls on the inside of the register box by hand. Often, many steps are required so as to properly fit the insulation material within the register box. Furthermore, since fibrous material is being manually handled by workers, there can be exposure to airborne fibers. The cutting and fitting of the insulation material within the register box is extremely tedious and boring to workers.

In the past, various patents have issued relating to register boxes and to the insulating of such register boxes. For example, U.S. Pat. No. 3,985,158, issued on Oct. 12, 1976 to J. V. Felter, describes a box for mounting diffusers wherein the main body of the box is made of expanded plastic or similar material. One or more connection elements are molded within the walls of the box to provide for connection of the box to the building structure and to a duct and also to reinforce the box.

U.S. Pat. No. 4,735,235, issued on Apr. 5, 1988 to Anderson et al., discloses an insulated duct end system. The system includes duct assemblies and transition components for interconnecting the duct assemblies. Each duct assembly includes an insulated duct having a rigid sleeve within at least one end. Each sleeve includes an abutment ring and orifices in the ring for permitting air to flow into the insulated area to balloon the layer and improve its insulative effect.

U.S. Pat. No. 5,095,942, issued on Mar. 17, 1992 to G. C. Murphy, teaches a plastic self-insulating ductwork system. The system includes a distribution box which includes an upper portion having a plurality of walls and a bottom plate. The distribution box is joined to interconnecting duct lines by adapter conduits. The adapter conduits are adapted at one end for connection to an opening in the wall and are adapted at the other end for connection to an adjoining duct line. U.S. Pat. No. 5,219,403, issued on Jun. 15, 1993 the G. C. Murphy, discloses a similar type of self-insulating ductwork system as that of U.S. Pat. No. 5,095,942.

U.S. Pat. No. 5,658,196, issued on Aug. 19, 1997 to T. L. Swaim, provides an air duct diffuser for attachment to a ceiling grid. The diffuser includes a frame which mounts to the ceiling grid and a louver which mounts to the frame for directing diffused air within an associated airspace. A pre-formed composite housing of insulating material mounts to the frame and has punch-out duct openings of varying sizes.

U.S. Pat. No. 5,749,190, issued on May 12, 1998 to S. R. Williams, shows an HVAC register box having no welded or riveted corners and also a process for making such an HVAC register box. The register box is fabricated from a single sheet of material without cutting. The register box has superior rigidity and resistance to air leakage at the joints or corners.

U.S. Pat. No. 5,957,506, issued on Sep. 28, 1999 to M. D. Stepp, provides a sheet-metal insulated register box. The register box has an adjustable elbow fitting that is coupled directly to an air inlet panel of an air distribution register box by having roll-formed flange portions that are mated in interlocking, overlapping engagement with each other. The air inlet panel includes an outwardly flared coupling flange bordering an air inlet opening. The neck of the sheet-metal elbow includes a folded coupling flange that is dimensioned for interfitting, overlapping engagement with the outwardly-flared elbow coupling flange.

U.S. Patent Publication No. 2008/0014860, published on Jan. 17, 2008 to Heitman et al., discloses a method and apparatus for eliminating register boxes. A collar plate assembly interfaces with metal air ducts and is provided with at least one spring indentation ring to accept two or more locking springs. The locking springs are used to attach the ceiling register to the collar plate assembly. The collar plate assembly uses mounting rails that attach the assembly to either the ceiling or wall supports. A trim ring is inserted in the cutout that attaches between the collar in the ceiling so as to eliminate air leakage and so as to provide an essentially smooth flow of air from the supply duct to the inside of the structure.

U.S. Patent Publication No. 2004/0130154, published on Jul. 8, 2004 to Stepp et al., shows a substantially airtight register box for HVAC systems. The register box has a body formed from at least one planar sheet. The body has an inlet and outlet. At least one of the inlet and the outlet is formed by folding corners of the planar sheet to form planar sides that lie in intersecting planes. The enclosure is then mounted to a surface of an interior area of a structure and is connected to ducts for communicating air between the interior area at a central air-handler unit.

U.S. Patent Publication No. 2008/0045137, published on Feb. 21, 2008 F. Rosal, discloses an insulated plenum box for heating, ventilating and air conditioning duct systems. This plenum box has insulation sprayed onto either the inside or outside of the plenum box in order to match the R-value of the connecting insulated duct.

The present Applicant is the owner of several patents and patent application publications related to such register boxes and the processes for forming such register boxes. For example, U.S. Patent Application No. 2018/0363942, published on Dec. 20, 2018 to the present Applicant, describes an insulated register box and process for forming the insulated register box. This register box has a body with a plurality of side walls arranged in a generally rectangular or square configuration and a plurality of flanges extending inwardly from the plurality of side walls. An expandable polymeric material is affixed to an inner side of each of the plurality of side wall such that the expandable polymeric material has a portion extending across one end of the body inwardly of the plurality of flanges. A sheet is positioned over the portion of the expandable polymeric material at one end of the body such that the sheet is interposed between the plurality of flanges and the portion of the expandable polymeric material. The expandable polymeric material and the sheet are cuttable so as to open to the interior of the register box.

U.S. Pat. No. 10,648,695, issued on May 12, 2020 to the present Applicant, describes a register box with a boot rail adapter that has an insulating material affixed within the register box, a guide rail affixed to a side panel of the register box, and a rail having a section received in a slot of the rail guide. The rail is adapted to be affixed to a supporting surface, such as a joist. The rail guide is slidable relative to the rail. The rail guide is affixed to an exterior surface of the side panel.

U.S. Pat. No. 10,309,682, issued on Jun. 4, 2019 to the present Applicant, teaches a process for insulating a register box in which the register box has a plurality of side panels arranged in a generally rectangular configuration and a duct opening through a wall that extends across the generally rectangular configuration. This process involves flowing an expandable polymeric material toward the plurality of side panels, placing the register box into or onto a support structure, introducing a liner over the flowed expandable polymeric material within the register box, and placing a form onto the liner in the register box so as to shape the expandable polymeric material within the register box. The form and the liner then removed from the register box.

U.S. Patent Application Publication No. 2018/0320921, published on Nov. 8, 2018 to the present Applicant, teaches an insulated register box apparatus with a boot rail adapter which has an insulating material affixed within the register box, a rail affixed to a side panel of the register box, and a rail guide having a slot that receives a section of the rail therein. The rail guide is adapted to be affixed to a supporting surface. The rail is affixed at least one of the side panels of the register box. The rail is slidable relative to the rail guide. The register box has a plurality of side panels and a duct that opens to an interior of the plurality of side panels. The insulating material extends inwardly of the plurality of side panels.

U.S. Patent Application Publication No. 2018/0187919, published on Jul. 5, 2018 to the present Applicant, teaches an insulated register box for HVAC installations that has a body with a plurality of side panels arranged in a generally rectangular or square configuration and a wall extending across the rectangular configuration. A duct opens through the wall so as to communicate with an interior of the body. An expandable foamed polymeric material is affixed to an inner side of the side panels. The wall has a surface extending from the opening of the duct to the side panels. The expandable foamed polymeric material is affixed to the surface of the wall.

U.S. Pat. No. 9,951,969, issued on Apr. 24, 2018 to the present Applicant, describes an insulated register box and a method for forming such an insulated register box. The register box has a body with a plurality of side panels arranged in a generally rectangular or square configuration and a wall extending across the rectangular configuration. A duct opens through the wall so as to communicate with the interior of the body. An expandable foamed polymeric material is affixed to an inner side of the side panels. The wall has a surface extending from the opening of the duct to the side panels. The expandable foamed polymeric material is affixed to the surface of the wall.

Upon the commercialization of the insulated register box of U.S. Pat. No. 9,951,969, it was determined that certain operations and HVAC systems had different sizes of duct and different needs associated with the insulated register box. In particular, in this prior patent, the duct was of a particular size and was integrated in the structure of the register box. However, difficulties could occur if a customer had a duct system or air movement system which was incompatible with the duct that was incorporated into the structure of the register box. Under such circumstances, creative efforts would be required so as to fit a large duct of the HVAC systems with the smaller collar of the register box. Similarly, other creative efforts would be required in order to properly secure a smaller duct with a wider collar of the register box. This adaptation and creative efforts would require relatively skilled personnel in order to complete a secure and airtight connection. As such, a need developed so as to create a more adaptable register box in which a person can create an opening in the register box that is adaptable to the particular ducting and air movement systems to which the insulated register box is applied. In such a situation, it is important that the insulating expandable polymeric material be adaptable so as to generally engage with the exterior of the external ducting to which the insulated register box is applied. This need requires the ability to connect the register box to the ductwork without special tools, installation equipment, or complicated procedures.

It is object of the present invention to provide a register box that is adaptable to the ductwork of an HVAC system.

It is another object of the present invention to provide a register box that has a better seal when installed with the HVAC system.

It is another object of the present invention to provide a register box that can be customized to the particular ductwork of the HVAC system.

It is another object of the present invention to provide a register box that provides the unskilled worker with a guide in order to form a correctly cut and dimensioned hole in the register box.

It is another object of the present invention to provide a register box that allows unskilled workers to install the register box with the HVAC system.

It is another object the present invention to provide a register box that is energy efficient.

It is another object of the present invention to provide a register box that is relatively inexpensive.

It is a further object of the present invention to provide a register box that has a smaller footprint when shipping and storing.

It is another object of the present invention to provide a register box that minimizes air loss.

It is another object of the present invention to provide a register box that improves insulation rating.

It is another object of the present invention to provide a register box that is fire resistant.

It is another object to the present invention to provide a register box that is compliant with national building codes.

It is a further object of the present invention to provide a register box that avoids fibrous insulation.

It is still another object of the present invention to provide a register box that improves the health and safety of the workers.

These and other objects and advantages of the present invention will become apparent from a reading of the attached specification and appended claims.

### BRIEF SUMMARY OF THE INVENTION

The present invention is a register box for an HVAC installation. This register box has a body having a plurality of side panels arranged in a generally rectangular or square configuration and a wall extending generally transverse to the plurality of side panels. An expandable polymeric material is affixed to an inner side of each of the plurality of side panels and across at lest a portion of the wall. The plurality of side panels define an opening opposite the wall. The wall has a plurality of concentric circular areas cut into the wall.

Each of the plurality of concentric circular areas comprises a first partial circle having ends in spaced relation to a second partial circle. The ends of the first and second partial circles are spaced apart equally for each of the plurality of concentric circular areas. The plurality of concentric circular areas, in the preferred embodiment of the present invention, is at least three circular areas of differing diameters. Each of the plurality of concentric circular areas is formed centrally of the wall.

At least one of the plurality of concentric circular areas is selectively removable. A collar is affixed to the box. This collar extends through the selectively removed circular area and through the expandable polymeric material so as to open to an interior of the body. The body is formed of thirty gauge galvanized sheet steel in the preferred embodiment of the present invention.

The present invention is also a method for forming an insulated register box. This method includes the steps of: (1) forming a sheet of metallic material into a generally box shape having a plurality of side panels and a wall extending across an area defined by the plurality of side panels; (2) cutting a plurality of concentric circular areas into the wall; and (3) injecting an expandable polymeric material into an interior of the box shape. The plurality of side panels define an opening opposite the wall. The expandable polymeric material adheres to the plurality of side panels and to the wall.

The step of cutting includes laser or plasma cutting the plurality of concentric circular areas into the wall. Specifically, the step of cutting includes cutting a first circular area into the wall and cutting a second circular area into the wall. The first circular area has a diameter less than the diameter of the second circular area. In particular, a first partial circular area is cut into the wall and a second partial circular areas cut into the wall. The first partial circular area has a first end and a second end. The second partial circular area also has a first end and a second end. The first end of the second partial circular area is spaced from the first end of the first partial circular area. The second end of the second partial circular area is spaced from the second end of the second partial circular area.

One of the plurality of concentric circular areas is removed from the wall so as to expose the expanded polymeric material at the wall. A hole is cut in the expanded polymeric material. This hole opens to an interior of the register box. The hole has a diameter approximately equal to a diameter of the removed circular area.

A collar is placed into the cut hole and through the removed circular area such that the collar has one end positioned exterior of the register box and an opposite end interior of the register box. The circular area is removed by folding an edge of the circular area back-and-forth until the circular area separates from the wall. This folding is done across the space between the ends of the partial circular areas.

A sheet or panel can be placed over an exterior of the wall and over the plurality of concentric circular areas prior to and during the step of injecting the expandable polymeric material. The sheet is removed after the expandable polymeric material has expanded. The step of cutting includes cutting the plurality of concentric circular areas entirely through the thickness of the wall.

The present invention is also a method of connecting a register box to a duct of an HVAC system. This method includes the steps of: (1) forming a register box having a plurality of side panels and a wall extending across the plurality of side panels with an expandable polymeric material residing against the plurality of side panels and against the wall; (2) cutting a plurality of concentric circular areas into the wall; (3) removing at least one of the plurality of concentric circular areas from the wall so as to expose a portion of the expandable polymeric material residing against the wall and to define a hole in the wall opening to the expandable polymeric material; (4) cutting through the exposed portion of the expandable polymeric material so as to open to an interior of the register box; (5) inserting the collar through the hole in the wall and into the cut exposed portion of the expandable polymeric material; and (6) connecting the collar to the duct of the HVAC system.

The removed circular area has a diameter approximately equal to the diameter of the collar. The collar has a diameter approximately equal to a diameter of the duct of the HVAC system. The step of cutting the plurality of concentric circular areas comprises laser or plasma cutting the plurality of concentric circular areas into the wall. Each of the plurality of concentric circular areas has a pair of partial circles residing in spaced relation to each other.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is an upper perspective view of the register box in accordance with the teachings of the present invention.

FIG. 2 is a side elevational view of the register box in accordance with the teachings of the present invention.

FIG. 3 is a bottom view of the register box in accordance with the teachings of the present invention.

FIG. 4 is a cross-sectional view showing the register box in association with the present invention.

FIG. 5 is an upper perspective view showing the circular area at the top of the register box of the present invention.

FIG. 6 shows a cross-sectional view of the register box of the present invention with the collar installed.

FIG. 7 is a side elevational view of the register box of the present invention with the collar installed.

FIG. 8 is a bottom view of the register box the present invention with a different-sized collar installed therein.

### DETAILED DESCRIPTION OF THE INVENTION

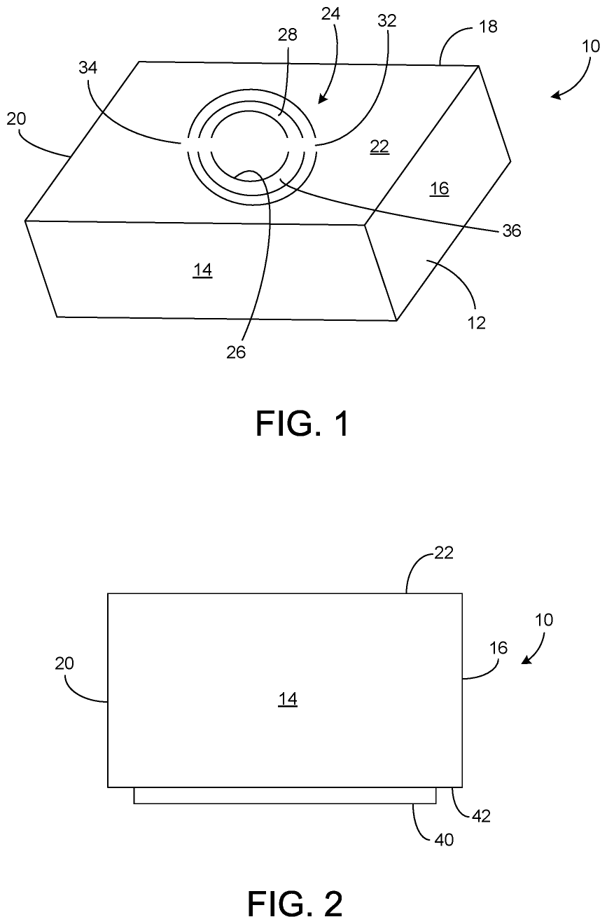

FIG. 1 shows the register box 10 in accordance with the teachings of the present invention. The register box 10 includes a body 12 having a plurality of side panels 14, 16, 18 and 20 arranged in a generally rectangular or square configuration. Side panels 16 and 20 extend between side panels 14 and 18. A wall 22 extends a generally transverse relation to the plurality of side panels 14, 16, 18 and 20. A plurality of concentric circular areas 24 is cut into the wall 22. The plurality of concentric circular areas 24 defines a first circular area 26, a second circular area 28 and a third circular area 30. Each of the circular areas 26, 28 and 30 is laser or plasma cut into the wall 22. Each of the circular areas 26, 28 and 30 has a different diameter. These cut circular areas extends through the thickness of the wall 22. Uncut spaces 32 and 34 are formed between ends of the partial circular areas of each of the concentric circular areas 26, 28 and 30. In particular, it can be seen that circular area 26 has a first portion that is separated by the second portion by the spaces 32 and 34. Similarly, the circular area 28 has portions that are separated by the uncut spaces 32 and 34. The circular area 30 has portions that are separated by the uncut spaces 32 and 34. The uncut spaces provide a place whereby each of the partial circles can be bent back and forth so as to separate from the wall 22 (in the manner to be described hereinafter). The different diameters of the circular areas 26, 28 and 30 allows the register box 10 of the present invention to be adaptable to various collars received therein and therethrough. These collars are in the nature of collars that can be connected to the ductwork of the HVAC system.

FIG. 2 shows a side view of the register box 10 of the present invention. In particular, FIG. 2 shows the side panel 14. Side panel 14 extends transverse to side panels 16 and 20. A flange 40 extends downwardly from the bottom 42 of the register box 10. Flange 40 defines an opening at the bottom 42 opposite the wall 22.

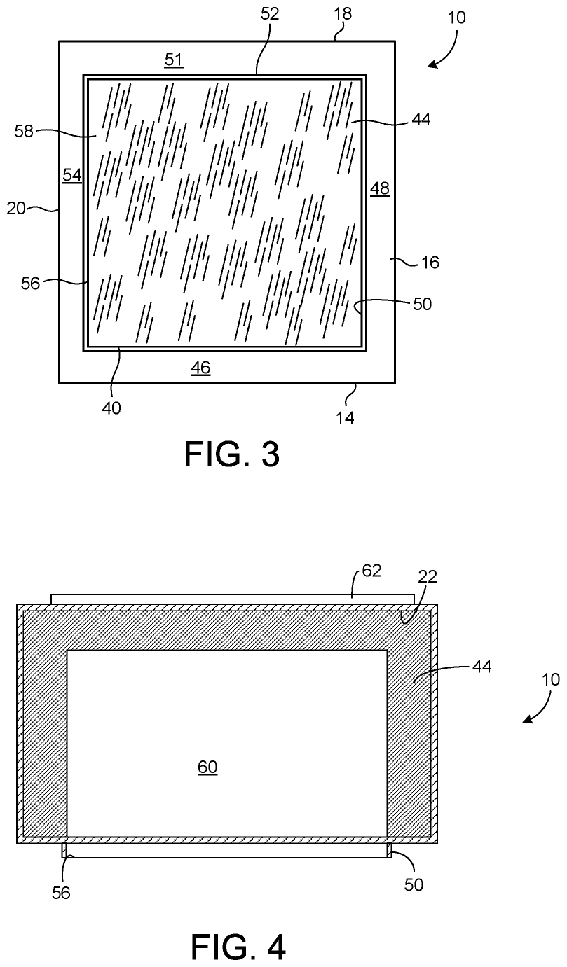

FIG. 3 shows the bottom view of the register box 10 of the present invention. In particular, in FIG. 3, the expanded polymeric material 44 within the interior of the register box 10 is particularly illustrated. This expanded polymeric material 44 will reside against the inner surface of the wall 22 and against the inner surfaces of the side panels 14, 16, 18 and 20.

In particular, FIG. 3 shows that the side panel 14 has a flange 46 extending inwardly therefrom. Flange 40 extends downwardly from an edge of flange 46 opposite the side panel 14. Similarly, side panel 16 has a flange 48 that extends inwardly therefrom. Another flange 50 will extend outwardly from the edge of flange 48 opposite to side panel 16. The side panel 18 has a flange 50 that extends inwardly therefrom. Another flange 52 will extend outwardly from the edge of flange 50 opposite to the side panel 18. Side panel 20 has a flange 54 extending inwardly therefrom. Another flange 56 will extend outwardly from flange 54 at an edge opposite the side panel 20. Flanges 40, 50, 52 and 56 define the opening 58. Opening 58 will be opposite to the concentric circular areas 24 on the wall 22. As will be described hereinafter, the expandable polymeric material 44 will reside against the side panels 14, 16, 18 and 20 and will be generally retained within the area of the flanges 40, 50, 52 and 56.

FIG. 4 shows the insulated register box 10 of the present invention with the expandable polymeric material 44 positioned within the interior of the register box 10. The void 60 is formed in the interior of the register box of the present invention in the manner described in conjunction with U.S. Patent Application Publication No. 2018/0363942 of the present Applicant. As can be seen, the expandable polymeric material is generally aligned with the flanges 50 and 56. The expandable polymeric material 44 will extend a similar distance away from the inner surface of the wall 22.

FIG. 4 shows the feature of the present invention during the manufacture of the insulated register box 10. Since the plurality of concentric circular areas 24 is cut entirely through the thickness of the wall 22, there is a possibility that when the expandable polymeric material expands, it could force its way through these concentric circular areas. This could bend or distort the wall 22. As such, a sheet or panel 62 is positioned and retained over the wall 22 during the introduction and expanding of the expandable polymeric material 44 within the register box 10. This will maintain the circular areas intact and in a generally planar configuration. Forces can be applied to the sheet or panel 62 so as to resist the forces resulting from the expanding of the polymeric material 44. It is also possible that a sticker can be the sheet 62. This sticker can have circular lines corresponding to be circular areas that have been cut into the wall 22. This type of sticker can serve to retain the circular areas in a planar configuration and can also allow a worker to properly envision the necessary areas to cut in order to expose the cut circular areas and remove the cut areas from the register box 10. Various other configurations of sheet or panel 62 can also be used so as to achieve this particular purpose.

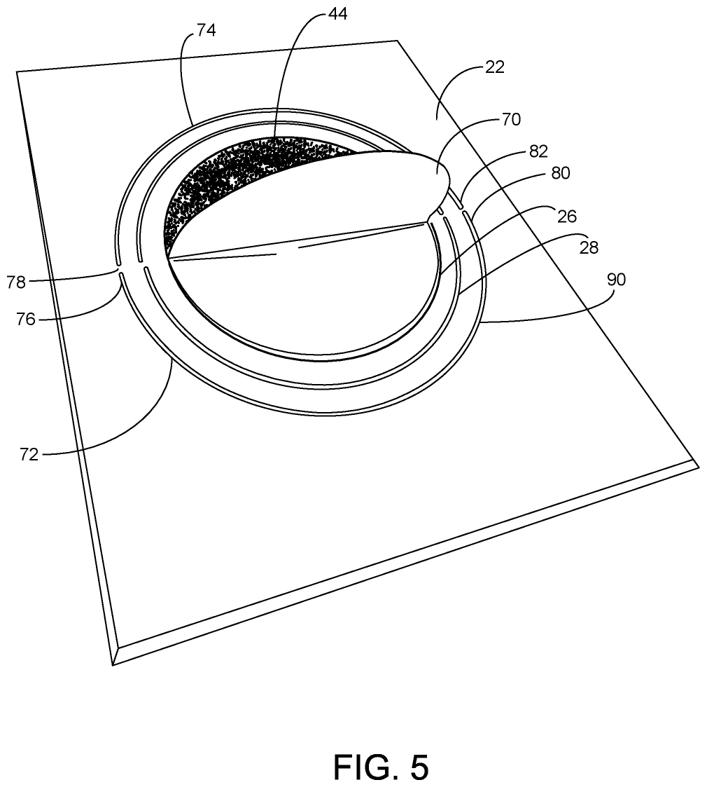

FIG. 5 illustrates the wall 22 during the removal of a circular area 70. In particular, FIG. 5 shows the concentric circular areas 26, 28 and 30. Concentric circular area 26 defines the circular area 70 therein. The circular area 70 is of thirty gauge galvanized stainless steel. Importantly, each of the concentric circular areas 26, 28 and 30 is sized so as to fit the various diameters of ductwork associated with HVAC systems. The concentric circular area 26 is for a smaller ducts. Concentric circular area 28 is formed intermediate size ducts. Concentric circular area 30 is for larger ducts. Importantly, so as to connect with the ductwork, the circular areas associated with these concentric circles circular areas 26, 28 and 30 can be selectively removed so as to allow a collar to be inserted therein (in the manner described hereinafter).

In FIG. 5, it can be seen that circular area 30 has a first partial circle 72 and a second partial circle 74. End 76 of partial circle 72 is spaced from end 78 of partial circle 74. Similarly, end 80 of partial circle 72 is separated from end 82 of partial circle 74. The similar spacing occurs with respect to the other concentric circular areas 26 and 28. The spacing allows the particular circular cut area to be folded back-and-forth so as to separate the circular cut area from the remainder of the wall 22. FIG. 5 shows circular cut 70 as being folded in this manner. It is only necessary to grab an edge of this cut circular cut, lift it, and fold it back-and-forth until the circular cut area is separated. This will expose the expandable polymeric material 44 located on the inner side of wall 22.

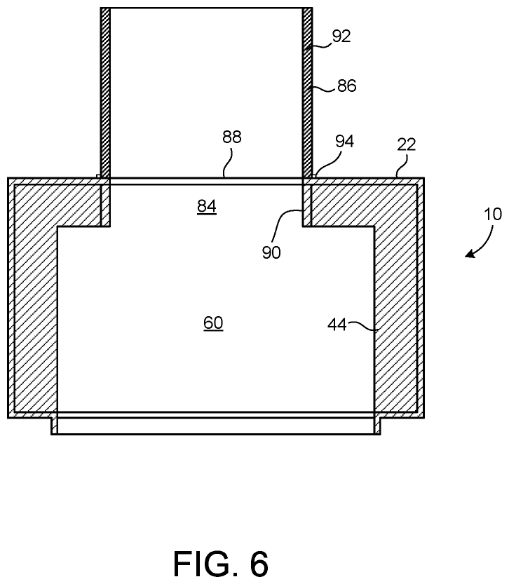

FIG. 6 shows a further step in the process of the present invention. In FIG. 6, the removed circular area 70 has been separated from the remainder of the wall 22 such that the expandable polymeric material 44 is exposed. A knife, or other device, can be used so as to saw through the expandable polymeric material 44 and to follow the outline of the circular area 26. This will allow the expandable polymeric material 44 in the interior of the circular area 26 to be removed and to expose the void 60 on the interior of the register box 10. Importantly, the configuration of the present invention makes it easy for a worker to create this hole in the expandable polymeric material 44. The edges of the cut circular areas can serve as a guide. As such, it is only necessary for a worker to extend a knife, or similar device, downwardly through the expandable polymeric material 44 and saw around the perimeter of the opening left by the removal of the circular area 70. As such, this will open area 84 within the register box 10. A collar 86, having a size corresponding to the diameter of the circular area 26, can then be inserted into the opening 88. As a result, collar 86 will have a portion 90 residing against the expandable polymeric material 44 and another portion 92 extending outwardly of the register box 10. Portion 92 can be engaged with the ductwork of an HVAC system. A sealant 94 can be applied at the area of the juncture between the collar 86 and the wall 22. The pliability of the expandable polymeric material 44 will ensure a tight seal between the exterior surfaces of portion 90 and the expandable polymeric material.

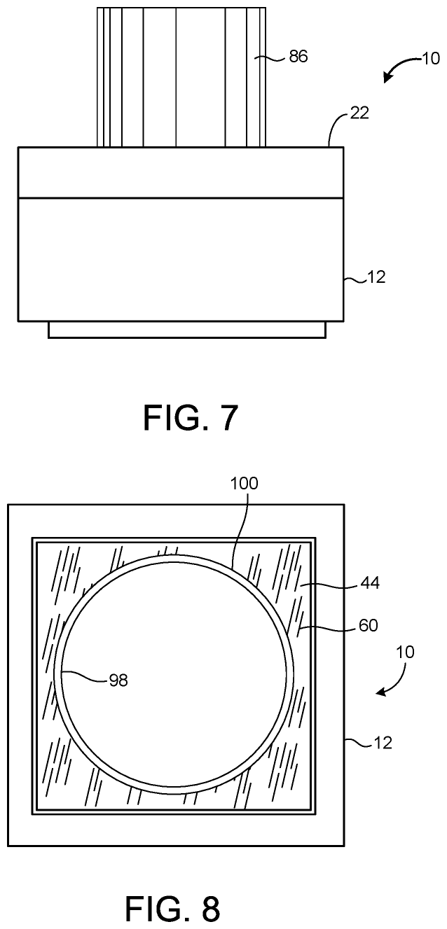

FIG. 7 shows an exterior view of the completed register box 10 in accordance with the present invention. It can be seen that there is a cylindrical collar 86 that extends upwardly from the wall 22 of the register box 10. The body 12 of the register box 10 will receive the portion 90 of the collar 86. Collar 86 is adapted to be affixed to the duct of the HVAC system.

FIG. 8 shows the register box 10 is used in association with a wider diameter collar 98. In this configuration, the concentric circular area 30 is removed (along with the concentric areas 28 and 26) so as to define a larger hole opening to the expandable polymeric material 44. As such, a wide diameter collar 98 is accommodated through the expandable polymeric material 44 and through the opening in the wall 22. This larger duct 98 will open to the void 60 within the interior of the body 12 of the register box 10. The expandable polymeric material 44 will envelop the exterior of the portion 100 of the wide diameter duct 98 so as to create a seal therewith.

The present invention offers a wide variety of advantages over the prior art. In particular, the present invention makes the register box of the present invention adaptable to ductwork of various HVAC systems. As such, it is not necessary for a customer to specify, with precision, the diameter of the ductwork of such an HVAC system. Furthermore, a common register box can be supplied for installation with various systems. Since the cut areas in the wall 22 of the present invention are matched to the diameter of the collar and the associated ductwork of the HVAC system, a much better seal is created when installed. Adaptation between unequal diameters is not required within the present invention. The present invention can be customized to the particular HVAC system and ductwork associated therewith.

The unique configuration of the present invention allows the cut circular areas to serve as a guide for the cutting of the expandable polymeric material when forming the hole opening to the void in the interior of the register box. This guide makes it easier for unskilled workers to form the proper diameter of the hole that accommodates the collar. As such, proper cuts are automatically achieved because of the configuration of the present invention. This allows unskilled workers to adapt the register box of the present invention to the various sizes of ductwork of HVAC systems.

The present invention can provide a smaller footprint for these storage, transportation of the register box. In the prior art, the collar has been automatically affixed to the register box. However, in the present invention, the collar can be shipped separate from the register box. The register box can easily be stacked one upon the other. This creates a very minimal footprint. The collars can be stored elsewhere for easy shipping. The installation of the collar within the register box can be carried out on-site with little or no difficulty.

The expandable polymeric material that is used on the interior of the register box of the present invention is very energy efficient. The expandable polymeric material can be easily installed. This is particularly true since the expandable polymeric material against the inner surface of the wall does not need to be pre-formed. As described in the previous applications to the present Applicant, the expandable polymeric material that is used for the installation of the register box of the present invention can be simply injected into the interior of the register box so as to expand around a plug placed in the interior. The expandable polymeric material minimizes air loss since it covers all surfaces on the interior of the register box. This will improve the insulation rating of the register box. Expandable polymeric material is fire resistant and compliant with national building codes. This expandable polymeric material avoids the use of fibrous insulation and, as such, will improve the health and safety of the workers.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A register box for an HVAC installation, the register box comprising:
a body having a plurality of side panels arranged in a generally rectangular or square configuration, said body having a wall extending generally transverse to the plurality of side panels, the plurality of side panels defining an opening opposite the wall, the wall having a plurality of concentric circular areas cut into the wall; and
an expandable polymeric material affixed to an inner side of each of the plurality of side panels and across at least a portion the wall.

2. The register box of claim 1, wherein each of the plurality of concentric circular areas comprise a first partial circle having ends in spaced relation to a second partial circle.

3. The register box of claim 2, wherein the ends of the first and second partial circles are spaced apart equally for each of the plurality of concentric circular areas.

4. The register box of claim 1, wherein the plurality of concentric circular areas are at least three circular areas of differing diameters.

5. The register box of claim 1, wherein each of the plurality of concentric circular areas is formed centrally of the wall.

6. The register box of claim 1, the body being formed of thirty gauge galvanized sheet steel.

7. The register box of claim 1, wherein at least one of the plurality of concentric circular area is selectively removable, the register box further comprising:
a collar affixed to the body, said collar extending through the selectively removed at least one of the plurality of concentric circular areas and through the expandable polymeric material so as to open to an interior of the body.

8. A method for forming an insulated register box, the method comprising:
forming a sheet of metallic material into a generally box shape having a plurality of side panels and a wall extending across an area defined by the plurality of side panels, the plurality of side panels defining an opening opposite the wall;
cutting a plurality of concentric circular areas into the wall; and
injecting an expandable polymeric material into an interior of the generally box shape, the expandable polymeric material adhering to the plurality of side panels and to the wall.

9. The method of claim 8, wherein the step of cutting comprises:
laser or plasma cutting the plurality of concentric circular areas into the wall.

10. The method of claim 8, wherein the step of cutting comprises:
cutting a first circular area into the wall; and
cutting a second circular area into the wall, the first circular area having a diameter less than the diameter of the second circular area.

11. The method of claim 10, wherein the step of cutting the first circular area comprises:
cutting a first partial circular area into the wall, the first partial circular area having a first end and a second end; and
cutting a second partial circular area in the wall, the second partial circular area having a first end and a second end, the first end of the second partial circular area being spaced from the first end of the first partial circular area, the second end of the second partial circular area being spaced from the second end of the second partial circular area.

12. The method of claim 8, further comprising:
removing one of the plurality of concentric circular areas from the wall so as to expose the expanded polymeric material at the wall; and
cutting a hole in the expanded polymeric material, the hole opening to an interior of the register box.

13. The method of claim 12, wherein the hole has a diameter approximately equal to a diameter of the removed one of the plurality of concentric circular areas.

14. The method of claim 12, further comprising:
placing a collar into the cut hole and through the removed one of the plurality of concentric circular areas such that the collar has one end positioned exterior of the register box and an opposite end interior of the register box.

15. The method of claim 12, the step of removing comprising:
folding an edge of one of the plurality of concentric circular areas back-and-forth until the one of the plurality of concentric circular area separates from the wall.

16. The method of claim 8, further comprising:
placing a sheet or panel over an exterior of the wall and over the plurality of concentric circular areas prior to and during the step of injecting the expandable polymeric material; and
removing the sheet or panel after the expandable polymeric material has expanded.

17. The method of claim 8, the step of cutting comprising:
cutting the plurality of concentric circular areas entirely through a thickness of the wall.

18. A method of connecting a register box to a duct of an HVAC system, the method comprising:
forming the register box having a plurality of side panels and a wall extending across the plurality of side panels, the register box having an expandable polymeric material residing against the plurality of side panels and against the wall;
cutting a plurality of concentric circular areas into the wall;
removing at least one of the plurality of concentric circular areas from the wall so as to expose a portion of the expandable polymeric material residing against the wall so as to define a hole in the wall opening to the expandable polymeric material;
cutting through the exposed portion of the expandable polymeric material so as to open to an interior of the register box;
inserting a collar through the hole in the wall and into the cut exposed portion of the expandable polymeric material; and
connecting the collar to the duct of the HVAC system.

19. The method of claim 18, wherein the removed at least one of the plurality of concentric circular areas has a diameter approximately equal to the diameter of the collar, the collar having a diameter approximately equal to a diameter of the duct of the HVAC system.

20. The method of claim 18, the step of cutting the plurality of concentric circular areas comprising:
laser or plasma cutting the plurality of concentric circular areas into the wall, each of the plurality of concentric circular areas being a pair of partial circles residing in spaced relation to each other.
